(19) United States
(12) Patent Application Publication
(10) Pub. No.: US 2025/0227406 A1
(43) Pub. Date: Jul. 10, 2025

(54) Earpiece with GPS receiver

(71) Applicant: BRAGI GmbH, München (DE)

(72) Inventors: Darko Dragicevic, München (DE); Peter Vincent Boesen, München (DE)

(73) Assignee: BRAGI GmbH, München (DE)

(21) Appl. No.: 19/093,042

(22) Filed: Mar. 27, 2025

Related U.S. Application Data
(63) Continuation of application No. 18/641,757, filed on Apr. 22, 2024, now Pat. No. 12,279,083.
Application No. 18/641,757 is a continuation of application No. 18/324,588, filed on May 26, 2023, now Pat. No. 11,968,491.
Application No. 18/324,588 is a continuation of application No. 17/739,865, filed on May 9, 2022, now Pat. No. 11,700,475.
Application No. 17/739,865 is a continuation of application No. 17/141,924, filed on Jan. 5, 2021, now Pat. No. 11,336,989.
Application No. 17/141,924 is a continuation of application No. 16/102,052, filed on Aug. 13, 2018, now Pat. No. 10,893,353.
Application No. 16/102,052 is a continuation of application No. 15/449,158, filed on Mar. 3, 2017, now Pat. No. 10,085,082.
(60) Provisional application No. 62/307,088, filed on Mar. 11, 2016.

(51) Int. Cl. H04R 1/10; G01S 19/14; G01S 19/34; G01S 19/49; H04S 7/00

(52) U.S. Cl. CPC H04R 1/1041; G01S 19/14; G01S 19/34; G01S 19/49; H04R 1/1016; H04R 1/1025; H04R 2420/07; H04R 2420/09; H04R 2460/07; H04S 7/304

(57) ABSTRACT

An earpiece includes an earpiece housing, a processor disposed within the earpiece, a speaker operatively connected to the processor, a microphone operatively connected the processor, and a global navigation satellite system (GNSS) receiver disposed within the earpiece. A system may include a first earpiece having a connector with earpiece charging contacts, a charging case for the first earpiece, the charging case having contacts for connecting with the earpiece charging contacts, and a global navigation satellite system (GNSS) receiver disposed within the charging case.

### PRIORITY STATEMENT

This application is a continuation of U.S. patent application Ser. No. 18/641,757 filed Apr. 22, 2024 which is a continuation of U.S. patent application Ser. No. 18/324,588 filed May 26, 2023 (now U.S. Pat. No. 11,968,491) which is a continuation of U.S. patent application Ser. No. 17/739,865 filed May 9, 2022 (now U.S. Pat. No. 11,700,475) which is a continuation of U.S. patent application Ser. No. 17/141,924 filed Jan. 5, 2021 (now U.S. Pat. No. 11,336,989) which is a continuation of U.S. patent application Ser. No. 16/102,052 filed Aug. 13, 2018 (now U.S. Pat. No. 10,893,353) which is a continuation of U.S. patent application Ser. No. 15/449,158 filed Mar. 3, 2017 (now U.S. Pat. No. 10,085,082) which claims priority to U.S. Provisional Patent Application 62/307,088, filed on Mar. 11, 2016, all of which are titled “Earpiece with GPS Receiver”, all of which are hereby incorporated by reference in their entireties.

### FIELD OF THE INVENTION

The present invention relates to wearable devices. More particularly, but not exclusively, the present invention relates to ear pieces.

### BACKGROUND

Earpieces have conventionally had extremely limited functionality and use. However, there are numerous problems in extending use including the lack of space and power considerations. What is needed is an improved earpiece and the ability to track or determine location of a user using an earpiece.

### SUMMARY

Therefore, it is a primary object, feature, or advantage of the present invention to improve over the state of the art.

It is a further object, feature, or advantage of the present invention to provide apparatus, methods and systems which allow earpieces to determine location of a user.

It is a still further object, feature, or advantage of the present invention to make use of available Global Navigation Satellite Systems to determine location.

Another object, feature, or advantage is to determine location of an earpiece in a manner limiting power consumption.

Yet another object, feature, or advantage is to determine location of an earpiece allowing for thermal management.

One or more of these and/or other objects, features, or advantages of the present invention will become apparent from the specification and following claims. No single embodiment need provide each and every object, feature, or advantage. Different embodiments may have different objects, features, or advantages. Therefore, the present invention is not to be limited to or by an objects, features, or advantages stated herein.

According to one aspect, an earpiece is provided. The earpiece includes an earpiece housing, a processor disposed within the earpiece, a speaker operatively connected to the processor, a microphone operatively connected the processor, and a global navigation satellite system (GNSS) receiver disposed within the earpiece. There may also be one or more inertial sensors disposed within the earpiece housing and operatively connected to the processor. The at least one inertial sensor may include an accelerometer. The processor may be adapted to determine when the GNSS receiver is not providing current location data and updating a current location of the earpiece based on a last available location from the GNSS receiver and data from the at least one inertial sensor. The earpiece may include a wireless transceiver to communicate a geospatial location determined by the GNSS receiver to another earpiece. The processor may be configured to turn the GNSS receiver off such as in the course of managing battery life or temperature conditions. The GNSS receiver may be a global positioning system (GPS) receiver.

According to another aspect, a method of maintaining a current location of an earpiece is provided. The method includes determining a geospatial location using a global navigation satellite system (GNSS) receiver disposed within the earpiece, updating a current location of the earpiece with the geospatial location, and updating the current location of the earpiece with data from one or more inertial sensors disposed within the earpiece. The step of updating the current location of the earpiece with data from the one or more inertial sensors disposed within the earpiece may be performed if the GNSS receiver is unable to determine a geospatial location such as when a satellite lock is not available or if the GNSS receiver is turned off such as to manage battery life or temperature.

According to another aspect, a system includes a first earpiece having a connector with earpiece charging contacts, a charging case for the first earpiece, the charging case having contacts for connecting with the earpiece charging contacts, and a global navigation satellite system (GNSS) receiver disposed within the charging case. The system may further include a processor disposed within the earpiece and/or an inertial sensor disposed within the earpiece. The system may be configured to convey a geospatial location from the charging case to the processor of the first earpiece. The geospatial location may be conveyed wirelessly from the charging case to the first earpiece. The geospatial location may be conveyed through the connector of the first earpiece. The system may be configured to set a current location using the geospatial location and then update the current location using data from the inertial sensor. The first earpiece may include an ear piece housing, a processor disposed within the earpiece housing, a microphone operatively connected to the processor, and a speaker operatively connected to the processor. The GNSS receiver may be a global positioning system (GPS) receiver.

According to another aspect, a method of maintaining a current location of an earpiece is provided. The method includes determining a geospatial location using a global navigation satellite system (GNSS) receiver disposed within an earpiece charging case, conveying the geospatial location from the earpiece charging case to an earpiece configured to fit within the earpiece charging case for charging, and updating a current location of the earpiece with the geospatial location. The method may further include updating the current location of the earpiece based on movement of the earpiece determined from one or more inertial sensors.

### BRIEF DESCRIPTION OF THE DRAWINGS

FIG. 1 illustrates a left earpiece and a right earpiece.

FIG. 2 is block diagram illustrating an earpiece with a GNSS receiver.

FIG. 3 is another block diagram illustrating an earpiece with a GNSS receiver.

FIG. 4 is a flow chart illustrating one method of determining location of an earpiece.

FIG. 5 illustrates a pair of earpieces and a charging case.

FIG. 6 illustrates another view of a charging case.

FIG. 7 is a block diagram illustrating a charging case.

FIG. 8 is a flow chart illustrating another method of determining location of an earpiece.

### DETAILED DESCRIPTION

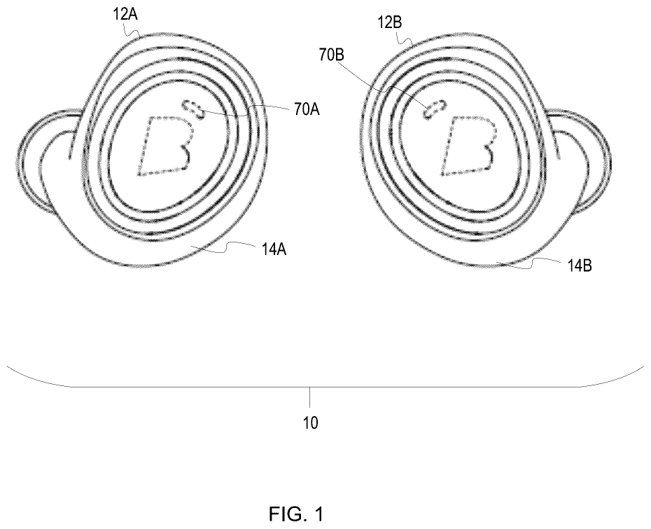

FIG. 1 illustrates a set of earpieces 10 including a left earpiece 12A and a right earpiece 12B. The left earpiece 12A has a housing or casing 14A and the right earpiece 12B has a housing or casing 14B. A microphone 70A is shown on the left earpiece 12A and a microphone 70B is shown on the right earpiece 12B.

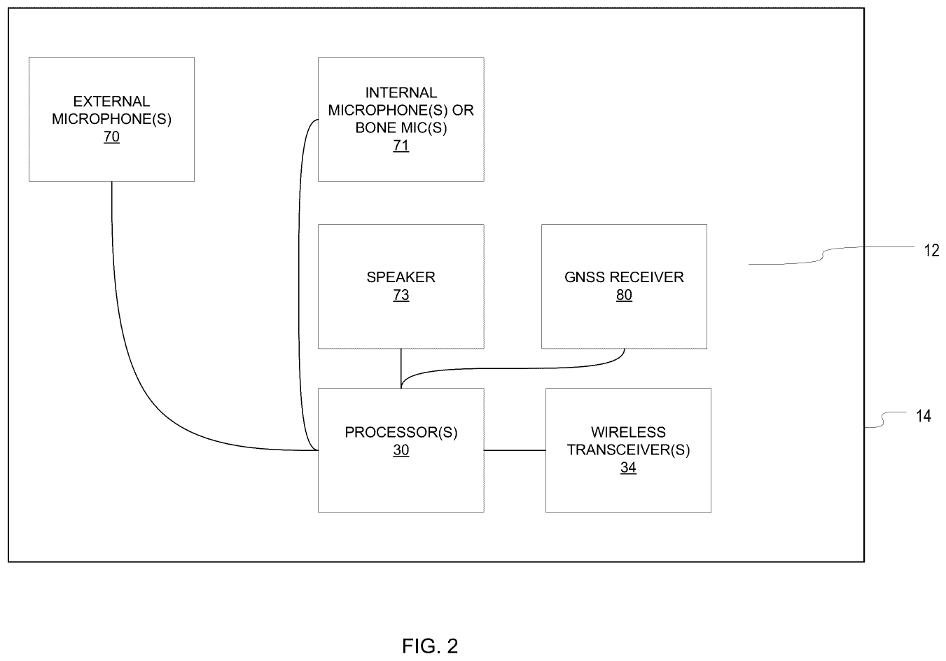

FIG. 2 illustrates an earpiece 12 which may be a left earpiece or a right earpiece. One or more processors or other intelligent controls 30 are shown disposed within the housing 14 of the earpiece. One or more wireless transceivers 34 are operatively connected to the processors 30. The wireless transceivers 34 may include a BLUETOOTH transceiver, an ultra-wideband (UWB) transceiver, or type of radio transceiver, a near field magnetic induction (NFMI) transceiver, or other type of transceiver. One or more external microphones 70 is operatively connected to the processors 30 as are one or more internal microphones or bone microphones 71. A global navigation satellite system (GNSS) receiver is also disposed within the housing 14 of the earpiece 12. The GNSS receiver may be a Global Positioning System (GPS) receiver a Globalnaya Navigazionnaya Sputnikovaya Sistema (GLOSNASS) receiver or other type of GNSS receiver.

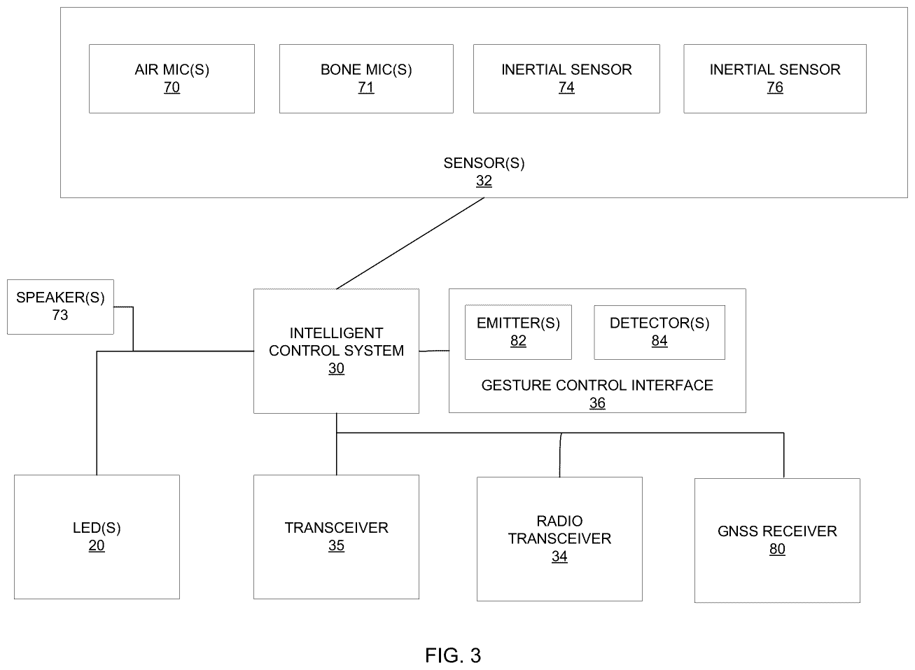

FIG. 3 is a block diagram illustrating an earpiece. The earpiece may include one or more sensors 32. The sensors may include one or more air microphones 70, one or more bone microphones 71, and one or more inertial sensors 74, 76. Each of the one or more sensors 32 is operatively connected to an intelligent control system 30. The intelligent control system 30 may also be operatively connected to a gesture control interface 36 which may include one or more emitters 82 and one or more detectors 84. The gesture control interface 36 allows a user to interact with the earpiece through gestures or motions which are detected by the gesture control interface and interpreted by the intelligent control system 30. One or more speakers 72 is operatively connected to the intelligent control system 30. One or more light emitting diodes 20 are operatively connected to the intelligent control system 30 potentially used to provide visual feedback indicative of earpiece functionality or status. A radio transceiver 34 is shown as well as a second transceiver 35 which may be an NFMI transceiver or other type of transceiver.

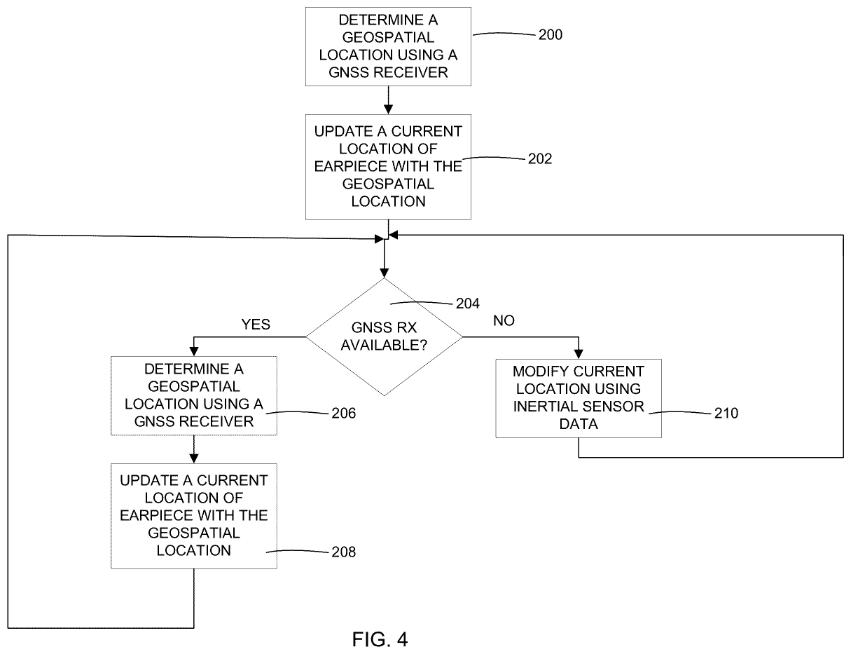

FIG. 4 illustrates one example of a methodology. In step 200 a determination is made regarding a geospatial location using a GNSS receiver. A geolocation or position is determined in step 200 and in step 202 a current location of the earpiece may be updated with the geospatial location. In step 204 a determination is made as to whether the GNSS receiver is still available. It is contemplated information from the GNSS receiver may not always be available for several reasons. First, in order to extend battery life of the earpiece or to otherwise better manage battery life the earpiece may turn off the GNSS receiver of the earpiece. Thus, when turned off the GNSS is not considered available. There are other instances where the GNSS receiver may also be turned off. For example, if the temperature associated with the earpiece exceeds a threshold the GNSS receiver may be turned off as a part of thermal management procedures. Regardless of whether the GNSS receiver is off or on it may not always be available to provide position information. For example, if the earpiece is indoors, underground, in an area where there is interference, the signal is being jammed, the GNSS receiver is unable to get a satellite lock and unable to provide position data. In these instances, when the GNSS is not available (for whatever reason(s)), position may still be determined or tracked. This is performed by using information from one or more inertial sensors providing inertial sensor data. The inertial sensor data may be used to sense or infer movement. The earpiece may calculate a current location based on changes in position determined from the inertial data. Thus position may be determined even though a geolocation is not available directly from the GNSS receiver.

Below is one example of pseudo-code which may be used to determine a current location using a GNSS receiver if available and calculate a current location from a last known location and inertial data.

```
If GNSS_receiver_available:
  current_loc = Get_geoloc( )
      current_loc_time = Get_time( )
    else:
      current_loc = calculate_loc (current_loc, current_loc_time)
      current_loc_time = Get_time( )
```

It is contemplated; however, this methodology may be implemented in any number of ways to reduce the processing resources used. For example, position may only be updated when the amount of change in position as determined by the inertial sensor exceeds a particular threshold. Similarly, if the inertial sensors determine there is very little change in position then the earpiece may turn off or power down or change modes of power consumption for the GNSS receiver to conserve resources. For example, the pseudo-code below illustrates one way of powering down the GNSS if the earpiece is not moving or has entered a power saving mode.

```
If not_moving or power_save_mode:
  PowerdownGNSS( )
  GNSS_receiver_available = 0
```

It is contemplated; however, the methodology may be implemented in any number of ways in addition to what is shown and described herein.

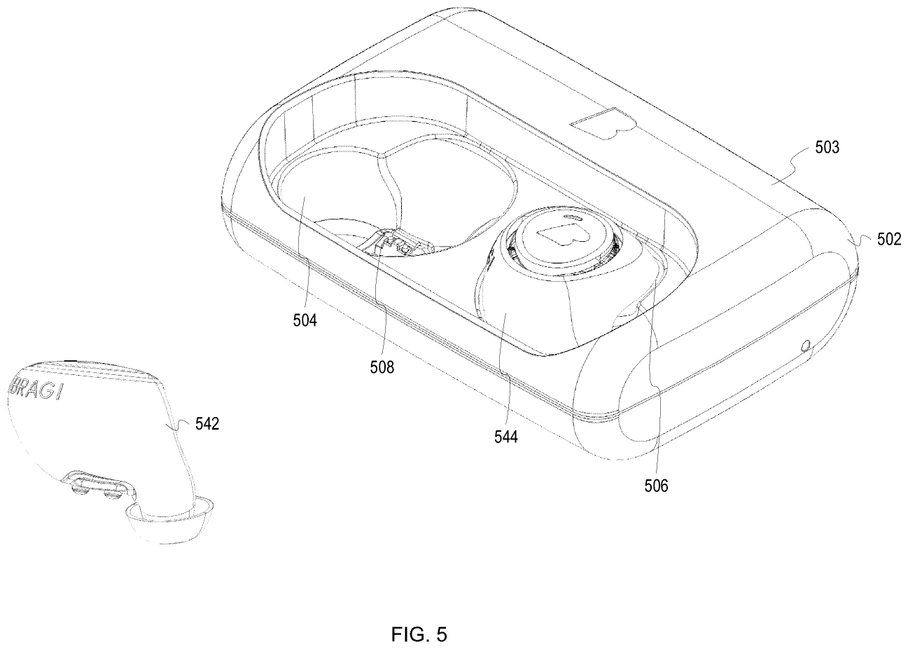

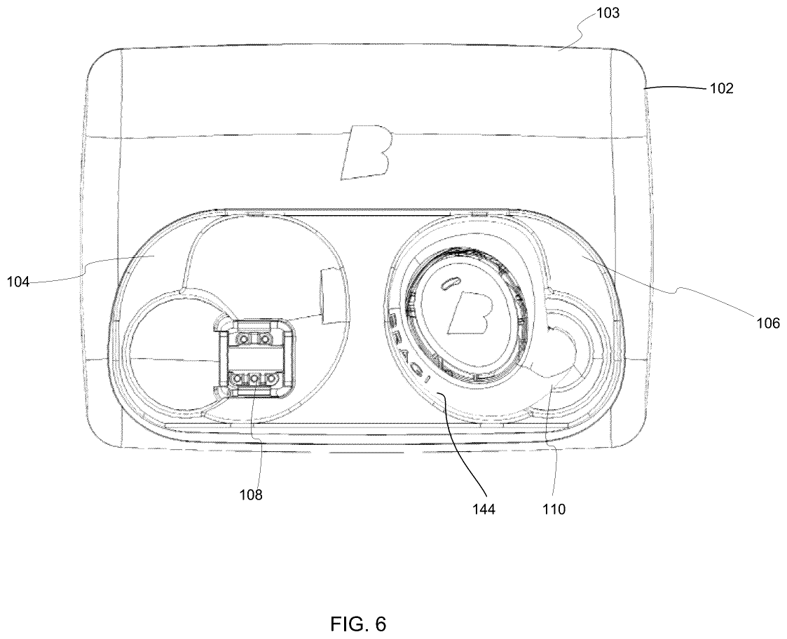

Instead of or in addition to having a GNSS receiver in one or more earpieces, the one or more earpieces may have a charging case associated with them. FIG. 5 illustrates one example of a charging case 502 with a case housing 503. A first earpiece area 504 and a second earpiece area 506 are shown for receiving earpieces 12A, 12B, respectively. The earpieces 12A, 12B are matingly connected or otherwise come in contact with contacts 508, 506. Thus, for example the contacts 510 of earpiece 12A come into contact with the contacts 508 of the charging case 502. When earpieces 12A, 12B are received in the earpiece areas 504, 506, the connections are made to allow for charging of the earpieces 12A, 12B as well as data communication directly from the charging case 502 the earpieces 12A, 12B. FIG. 6 illustrates another view of the charging case 502 to show the contacts 508 of the charging case 502 at a different angle. The contacts may take on multiple forms, shapes, sizes, connectors, or materials.

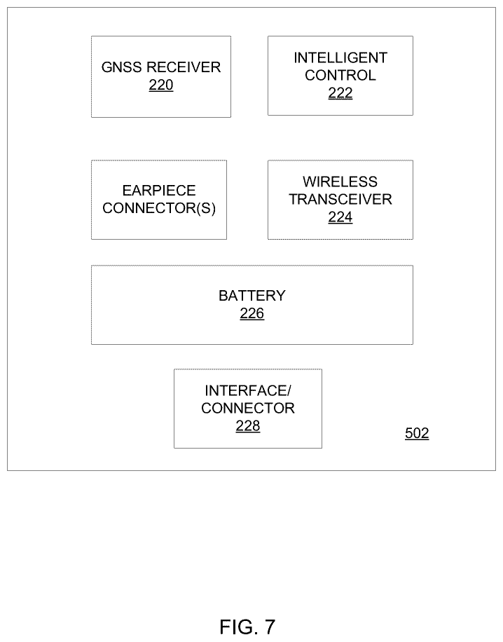

FIG. 7 illustrates a block diagram of one embodiment of a charging case 502. The charging case 502 may include a GNSS receiver 220, an intelligent control 222 operatively connected to the GNSS receiver 220, one or more earpiece connectors 508 for coming in contact with the earpiece and operatively connected to the intelligent control 222, a wireless transceiver 224 operatively to the intelligent control 222, a battery 226 disposed within the housing of the charger 502 and an interface/connector 228 which may be a USB type interface to allow the charger 502 to be charged. The wireless transceiver 224 may receive position information determined by the GNSS receiver 220 and wirelessly communicate the position information to one or more earpieces when the one or more earpieces are not connected. The GNN receiver 220 may also communicate position information to one or more earpieces when the earpieces are connected to the charging case.

It is contemplated in many applications the earpieces are not located far from the charging case such as when a person is using the earpieces at home, at work, at the gym, or while travelling. In addition, the charging case may be plugged-in and charged more regularly and the battery 226 may have greater capacity than any batteries in the earpieces. Thus, it may be advantageous in certain implementations to place the GNSS receiver 220 in the charging case 502. Thus, the earpieces still have access to GNSS position data and can use the data as an approximate position of the earpieces or calculate position based on a combination of last GNSS position and movement of the earpieces as determined by inertial sensors of the earpieces as previously discussed.

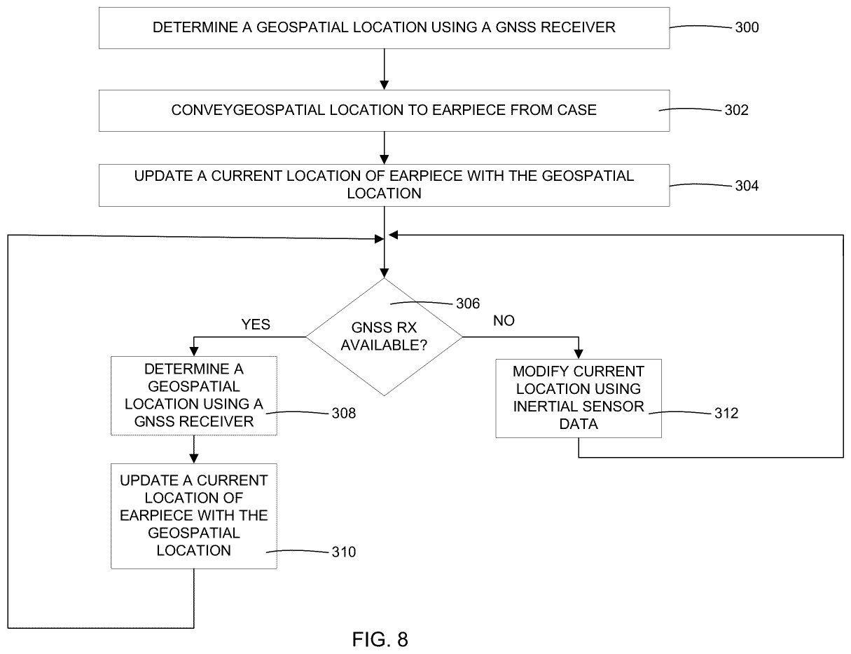

FIG. 8 illustrates one example of a method. In step 300 a geospatial location is determined using a GNSS receiver. In step 302 the geospatial location is conveyed from the case to the earpiece. This can be through an electrical connection such as when the earpiece is present within the case or can through wireless communication. Alternatively, the geospatial location may be conveyed wirelessly. Next in step 304, the current location of the earpiece may update with the geospatial location. Then in step 306 a determination is made as to whether the GNSS receiver is available. This means there is a connection with the case (either wired or wireless) and the GNSS receiver is receiving location information. If it is not, then in step 312 the current location of the earpieces may be modified using inertial sensor data from one or more sensors of the earpiece. If it is, then in step 308 a geospatial location may be determined using the GNSS receiver and the current location of the earpiece may be updated with the geospatial location.

Thus, an earpiece with a GNSS receiver or which uses a GNSS receiver in its case has been shown and described. The present invention contemplates numerous variations, options, and alternatives including the location of the GNSS receiver, the type of GNSS receiver, the specific algorithms used, the type of materials, and tools used to implement the invention, the number and type of sensors present, the number and type of transceivers present, and any number of other variations.

What is claimed is:

1. A system comprising:
a wireless earpiece comprising: an earpiece housing configured to fit within an ear of a user, a wireless transceiver disposed within the earpiece housing, an inertial sensor disposed within the earpiece housing configured to detect movement of the wireless earpiece, and a processor disposed within the earpiece housing, the processor configured to determine location updates of the wireless earpiece based on inertial sensor data; and
a separate wireless device comprising: a global navigation satellite system (GNSS) receiver configured to determine a geospatial location of the separate wireless device, an intelligent control operatively connected to the GNSS receiver and configured to store the geospatial location determined by the GNSS receiver in the separate wireless device, and a wireless transceiver configured to communicate with the wireless earpiece;
wherein the geospatial location stored in the separate wireless device corresponds to a last-known location of the wireless earpiece when the wireless earpiece and the separate wireless device are in wireless communication.

2. The system of claim 1, wherein the wireless earpiece updates its location based on inertial sensor data when wireless communication between the wireless earpiece and the separate wireless device is interrupted.

3. The system of claim 1, wherein the separate wireless device is a mobile phone.

4. The system of claim 1, wherein the separate wireless device further comprises a memory configured to store multiple last-known geospatial locations over time.

5. The system of claim 1, wherein the separate wireless device further comprises a user interface configured to display the last-known geospatial location of the wireless earpiece.

6. The system of claim 1, wherein the separate wireless device automatically stores the geospatial location determined by the GNSS receiver responsive to a loss of wireless communication with the wireless earpiece.

7. The system of claim 1, wherein the separate wireless device communicates with the wireless earpiece using a Bluetooth wireless protocol.

8. The system of claim 1, wherein the processor of the wireless earpiece is configured to reset its determined location when wireless communication is re-established with the separate wireless device.

9. The system of claim 1, wherein the wireless earpiece further comprises a microphone operatively connected to the processor and a speaker operatively connected to the processor.

10. The system of claim 1, wherein the separate wireless device is configured to transmit the stored geospatial location to a remote server.

11. The system of claim 10, wherein the separate wireless device is further configured to receive from the remote server a previously stored geospatial location.

12. The system of claim 1, wherein the wireless earpiece further comprises a battery operatively connected to the processor.

13. The system of claim 12, wherein the processor is configured to manage power consumption of the wireless earpiece based on inertial sensor activity.

14. The system of claim 1, wherein the intelligent control is further configured to determine the geospatial location periodically.

15. The system of claim 1, wherein the separate wireless device includes a user input configured to manually trigger storage of the geospatial location.

16. The system of claim 1, wherein the wireless earpiece is configured to provide audio alerts related to the geospatial location.

17. The system of claim 1, wherein the wireless transceiver of the separate wireless device is configured to detect signal strength from the wireless earpiece to assist in proximity determination.

18. The system of claim 1, wherein the wireless earpiece further comprises visual indicators operatively connected to the processor to provide status updates.

19. The system of claim 1, wherein the wireless earpiece and separate wireless device exchange authentication signals upon initial wireless communication establishment.

20. The system of claim 1, wherein the separate wireless device comprises an accelerometer configured to activate the GNSS receiver upon detecting device movement.
